(19) United States
(12) Patent Application Publication
(10) Pub. No.: US 2026/0125985 A1
(43) Pub. Date: May 7, 2026

(54) TURBINE AND MANUFACTURING METHOD OF TURBINE

(71) Applicant: IHI Corporation, Tokyo (JP)

(72) Inventors: Xianpeng REN, Tokyo (JP); Kenta KAWAMITSU, Tokyo (JP); Kotomichi KITAJIMA, Tokyo (JP)

(73) Assignee: IHI Corporation, Tokyo (JP)

(21) Appl. No.: 19/429,510

(22) Filed: Dec. 22, 2025

Related U.S. Application Data
(63) Continuation of application No. PCT/JP2024/021641, filed on Jun. 14, 2024.

(30) Foreign Application Priority Data
Oct. 10, 2023 (JP) 2023-175446

(51) Int. Cl. F01D 9/04; B23P 15/04

(52) U.S. Cl. CPC F01D 9/041; B23P 15/04; F05D 2230/232

(57) ABSTRACT

A turbine includes: a turbine blade wheel; a plurality of nozzle vanes arranged apart from each other in a circumferential direction of the turbine blade wheel on a radially outer side of the turbine blade wheel, the plurality of nozzle vanes provided in a freely rotatable manner about a rotation shaft in an axial direction of the turbine blade wheel; an annular member extending in the circumferential direction and freely rotatably provided in conjunction with the plurality of nozzle vanes; and an engagement portion including a pair of sliding surfaces provided on the annular member and facing each other in the circumferential direction, a driving member rotatably driven by an actuator and slidably engaged with the pair of sliding surfaces, the engagement portion having a thickness thicker than a thickness of a peripheral portion of the annular member.

### CROSS REFERENCE TO RELATED APPLICATIONS

This application is a continuation application of International Application No. PCT/JP2024/021641, filed on June 14, 2024, which claims priority to Japanese Patent Application No. 2023-175446, filed on October 10, 2023, the entire contents of which are incorporated by reference herein.

### DESCRIPTION

### BACKGROUND ART

### TECHNICAL FIELD

The present disclosure relates to a turbine and a manufacturing method of a turbine. The present application claims the benefit of priority based on Japanese Patent Application No. 2023-175446 filed on October 10, 2023, the content of which is incorporated herein.

### Related Art

In turbines used for a turbocharger or the like, there are cases where a nozzle vane for adjusting the flow velocity of exhaust gas is provided. For example, as disclosed in Patent Literature 1, a plurality of nozzle vanes are arranged apart from each other in the circumferential direction of a turbine blade wheel on a radially outer side of the turbine blade wheel. With each nozzle vane rotating, a cross-sectional area of a flow path formed between nozzle vanes adjacent to each other changes. As a result, the flow velocity of the exhaust gas flowing between the nozzle vanes adjacent to each other changes.

### Citation List

### Patent Literature

Patent Literature 1: JP 2004-116313 A

### SUMMARY

### Technical Problem

Each nozzle vane rotates in conjunction with an annular member rotated by an actuator. The annular member is provided with an engagement portion including a pair of sliding surfaces. A driving member rotatably driven by an actuator is slidably engaged with a pair of sliding surfaces of the engagement portion. As the driving member slides, wear of the engagement portion or the driving member occurs.

The object of the present disclosure is to provide a turbine and a manufacturing method of a turbine capable of suppressing wear.

### Solution to Problem

In order to solve the above problem, a turbine of the present disclosure includes: a turbine blade wheel; a plurality of nozzle vanes arranged apart from each other in a circumferential direction of the turbine blade wheel on a radially outer side of the turbine blade wheel, the plurality of nozzle vanes provided in a freely rotatable manner about a rotation shaft in an axial direction of the turbine blade wheel; an annular member extending in the circumferential direction and freely rotatably provided in conjunction with the plurality of nozzle vanes; and an engagement portion including a pair of sliding surfaces provided on the annular member and facing each other in the circumferential direction, a driving member rotatably driven by an actuator and slidably engaged with the pair of sliding surfaces, the engagement portion having a thickness thicker than a thickness of a peripheral portion of the annular member.

The annular member may include a main body corresponds to a portion of the annular member excluding the engagement portion, is separate from the engagement portion, and extends in the circumferential direction, and the engagement portion may be joined to the main body via at least one welding portion.

The main body may include a recessed portion recessed from a peripheral surface of the main body, a width in the circumferential direction of the recessed portion decreasing as the recessed portion is closer to a bottom, and the engagement portion may be joined to side surfaces of the recessed portion on both sides in the circumferential direction via the welding portion.

The engagement portion may include a first engagement portion joined to a first side surface of the recessed portion in the circumferential direction via the welding portion and a second engagement portion joined to a second side surface of the recessed portion in the circumferential direction via the welding portion, the second engagement portion separated from the first engagement portion in the circumferential direction, and the pair of sliding surfaces may include a first facing surface of the first engagement portion, the first facing surface facing the second engagement portion, and a second facing surface of the second engagement portion, the second facing surface facing the first engagement portion.

A first gap may be formed between the bottom and the first engagement portion, and a second gap may be formed between the bottom and the second engagement portion.

A first groove recessed in a direction away from the bottom may be formed on a side of the second engagement portion in a portion of the first engagement portion facing the bottom, and a second groove may be provided in a direction away from the bottom on a side of the first engagement portion in a portion of the second engagement portion facing the bottom.

In order to solve the above problems, a manufacturing method of a turbine according to the present disclosure includes the steps of: preparing a turbine blade wheel; arranging a plurality of nozzle vanes apart from each other in a circumferential direction of the turbine blade wheel on a radially outer side of the turbine blade wheel and providing the plurality of nozzle vanes in a freely rotatable manner about a rotation shaft in an axial direction of the turbine blade wheel; providing an annular member extending in the circumferential direction in a freely rotatable manner in conjunction with the plurality of nozzle vanes; and providing an engagement portion to the annular member, the engagement portion including a pair of sliding surfaces facing each other in the circumferential direction, a driving member rotatably driven by an actuator and slidably engaged with the pair of sliding surfaces, the engagement portion having a thickness thicker than a thickness of a peripheral portion of the annular member.

The step of providing the engagement portion to the annular member may include the steps of: preparing a main body corresponding to a portion of the annular member excluding the engagement portion, the main body being a separate body from the engagement portion and extending in the circumferential direction; and joining the engagement portion to the main body by welding.

The step of preparing the main body may include the step of forming a recessed portion in such a manner as to be recessed from a peripheral surface of the main body, the recessed portion in which a width in the circumferential direction decreases as the recessed portion is closer to a bottom, and the step of joining the engagement portion to the main body may include the step of joining the engagement portion to side surfaces of the recessed portion on both sides in the circumferential direction by welding.

The step of joining the engagement portion to the main body may include the steps of: joining a thick member having a thickness thicker than a thickness of the main body to side surfaces of the recessed portion on both sides in the circumferential direction by welding; and forming, as the engagement portion, by cutting the thick member, a first engagement portion joined to a first side surface of the recessed portion in the circumferential direction by welding and a second engagement portion joined to a second side surface of the recessed portion in the circumferential direction by welding and separated from the first engagement portion in the circumferential direction, and forming, as the pair of sliding surfaces, a first facing surface of the first engagement portion facing the second engagement portion and a second facing surface of the second engagement portion facing the first engagement portion.

The step of joining the engagement portion to the main body may include the step of joining the thick member to each of the side surfaces of the recessed portion on both sides in the circumferential direction by welding such that a first gap is formed between the bottom and the first engagement portion and a second gap is formed between the bottom and the second engagement portion.

The step of joining the engagement portion to the main body may include the step of cutting the thick member such that a first groove recessed in a direction away from the bottom is formed on a side of the second engagement portion in a portion of the first engagement portion facing the bottom and that a second groove recessed in a direction away from the bottom is provided on a side of the first engagement portion in a portion of the second engagement portion facing the bottom.

### Effects

According to the present disclosure, wear can be suppressed.

### BRIEF DESCRIPTION OF DRAWINGS

FIG. 1 is a schematic cross-sectional view illustrating a turbocharger according to the present embodiment.

FIG. 2 is a diagram obtained by extracting a first region in FIG. 1.

FIG. 3 is a diagram of a drive ring according to the present embodiment as viewed from a bearing housing side.

FIG. 4 is a diagram obtained by extracting a second region in FIG. 1.

FIG. 5 is a diagram obtained by extracting a third region in FIG. 3.

FIG. 6 is a cross-sectional view taken along line A-A in FIG. 5.

FIG. 7 is a diagram for explaining a first step in the manufacturing process of the drive ring according to the present embodiment.

FIG. 8 is a diagram for explaining a second step in the manufacturing process of the drive ring according to the present embodiment.

FIG. 9 is a diagram for explaining a third step in the manufacturing process of the drive ring according to the present embodiment.

### DESCRIPTION OF EMBODIMENTS

An embodiment of the present disclosure will be described below by referring to the accompanying drawings. Dimensions, materials, other specific numerical values, and the like illustrated in the embodiment are merely an example for facilitating understanding, and the present disclosure is not limited thereto unless otherwise specified. Note that, in the present specification and the drawings, components having substantially the same function and structure are denoted by the same symbol, and redundant explanations are omitted. Illustration of components not directly related to the present disclosure is omitted.

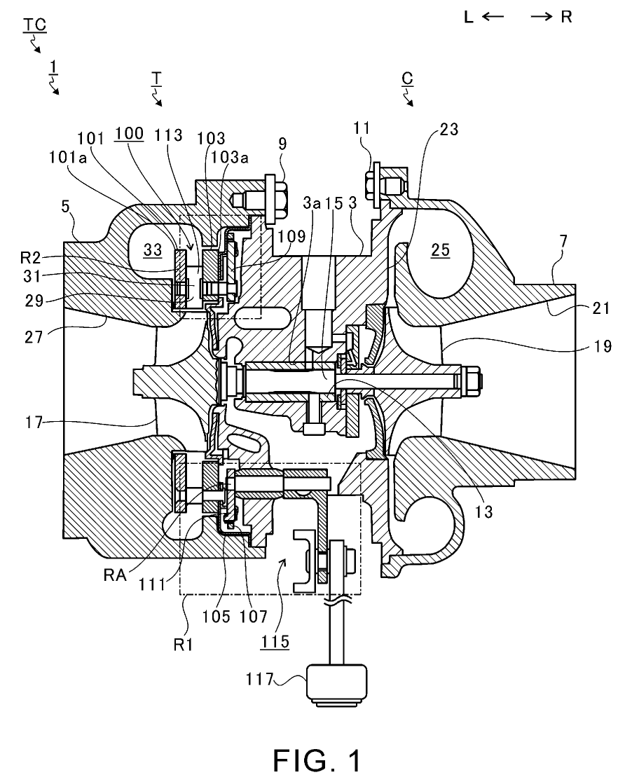

FIG. 1 is a schematic cross-sectional view illustrating a turbocharger TC according to the present embodiment. Hereinafter, description is given on the premise that the direction of an arrow L illustrated in FIG. 1 is the left side of the turbocharger TC. Description is given on the premise that the direction of an arrow R illustrated in FIG. 1 is the right side of the turbocharger TC. As illustrated in FIG. 1, the turbocharger TC includes a turbocharger main body 1. The turbocharger main body 1 includes a bearing housing 3, a turbine housing 5, and a compressor housing 7.

The turbine housing 5 is connected to the left side of the bearing housing 3 by a fastening bolt 9. The compressor housing 7 is connected to the right side of the bearing housing 3 by a fastening bolt 11. The turbocharger TC includes a turbine T and a centrifugal compressor C. The turbine T includes the bearing housing 3 and the turbine housing 5. The centrifugal compressor C includes the bearing housing 3 and the compressor housing 7.

A bearing hole 3a is formed in the bearing housing 3. The bearing hole 3a penetrates through the bearing housing 3 in the left-right direction of the turbocharger TC. A bearing 13 is disposed in the bearing hole 3a. In FIG. 1, a semi-floating bearing is illustrated as an example of the bearing 13. Incidentally, the bearing 13 may be another bearing such as a full-floating bearing or a rolling bearing. The bearing 13 pivotally supports a shaft 15 in a freely rotatable manner. At the left end of the shaft 15, a turbine blade wheel 17 is provided. The turbine blade wheel 17 is housed in the turbine housing 5 in a freely rotatable manner. At the right end of the shaft 15, a compressor impeller 19 is provided. The compressor impeller 19 is housed in the compressor housing 7 in a freely rotatable manner. The turbine blade wheel 17 and the compressor impeller 19 rotate integrally with the shaft 15.

Hereinafter, the axial direction, the radial direction, and the circumferential direction of the turbocharger TC are simply referred to as the axial direction, the radial direction, and the circumferential direction, respectively. The axial direction of the turbocharger TC coincides with the axial direction of the shaft 15, the axial direction of the turbine blade wheel 17, and the axial direction of the compressor impeller 19. The radial direction of the turbocharger TC coincides with the radial direction of the shaft 15, the radial direction of the turbine blade wheel 17, and the radial direction of the compressor impeller 19. The circumferential direction of the turbocharger TC coincides with the circumferential direction of the shaft 15, the circumferential direction of the turbine blade wheel 17, and the circumferential direction of the compressor impeller 19.

An intake port 21 is formed in the compressor housing 7. The intake port 21 opens to the right side of the turbocharger TC. The intake port 21 is connected to an air cleaner (not illustrated). A diffuser flow path 23 is formed between the bearing housing 3 and the compressor housing 7. The diffuser flow path 23 pressurizes the air. The diffuser flow path 23 extends in the circumferential direction and is formed in an annular shape. The diffuser flow path 23 communicates with the intake port 21 via a space where the compressor impeller 19 is disposed on the radially inner side.

A compressor scroll flow path 25 is formed in the compressor housing 7. The compressor scroll flow path 25 extends in the circumferential direction and is formed in an annular shape. The compressor scroll flow path 25 is positioned, for example, on the outer side in the radial direction with respect to the compressor impeller 19. The compressor scroll flow path 25 communicates with an intake port of an engine (not illustrated) and the diffuser flow path 23.

When the compressor impeller 19 rotates, the air is sucked from the intake port 21 into the compressor housing 7. The sucked air is pressurized and accelerated in the process of flowing between blades of the compressor impeller 19. The pressurized and accelerated air is further pressurized by the diffuser flow path 23 and the compressor scroll flow path 25. The pressurized air flows out from a discharge port (not illustrated) and is guided to the intake port of the engine.

An exhaust port 27 is formed in the turbine housing 5. The exhaust port 27 opens to the left side of the turbocharger TC. The exhaust port 27 is connected to an exhaust gas purification device (not illustrated). A gap 29 is formed between the bearing housing 3 and the turbine housing 5. A flow path 31 through which the exhaust gas flows is formed in the gap 29. The flow path 31 extends in the circumferential direction and is formed in an annular shape.

A turbine scroll flow path 33 is formed in the turbine housing 5. The turbine scroll flow path 33 is positioned on the radially outer side with respect to the turbine blade wheel 17. The flow path 31 is positioned between the turbine blade wheel 17 and the turbine scroll flow path 33. The flow path 31 allows the turbine scroll flow path 33 and the exhaust port 27 to communicate with each other via a space in which the turbine blade wheel 17 is disposed.

The turbine scroll flow path 33 communicates with a gas inlet port (not illustrated). Exhaust gas discharged from an exhaust manifold of the engine (not illustrated) is guided to the gas inlet port. The exhaust gas guided from the gas inlet port to the turbine scroll flow path 33 is guided to the exhaust port 27 via the flow path 31 and spaces between the blades of the turbine blade wheel 17. The exhaust gas guided to the exhaust port 27 rotates the turbine blade wheel 17 in the process of flowing therethrough.

The turning force of the turbine blade wheel 17 is transmitted to the compressor impeller 19 via the shaft 15. As described above, the turning force of the compressor impeller 19 causes the air to be pressurized and to be guided to the intake port of the engine.

When the flow rate of the exhaust gas introduced into the turbine housing 5 decreases, the rotation amount of the turbine blade wheel 17 decreases. When the rotation amount of the turbine blade wheel 17 decreases, the rotation amount of the compressor impeller 19 also decreases. When the rotation amount of the compressor impeller 19 decreases, the pressure of the air supplied to the intake port of the engine may not be sufficiently increased.

In the turbine housing 5, a variable capacity mechanism 100 is provided in the gap 29. The variable capacity mechanism 100 changes the cross-sectional area of the flow path 31 depending on the flow rate of the exhaust gas. For example, the variable capacity mechanism 100 reduces the cross-sectional area of the flow path 31 when the engine rotation speed is low and the flow rate of the exhaust gas is small.

When the cross-sectional area of the flow path 31 decreases, the flow velocity of the exhaust gas passing through the flow path 31 becomes faster than it is in a case where the cross-sectional area of the flow path 31 is large. As the flow velocity of the exhaust gas increases, the rotation amount of the turbine blade wheel 17 increases. When the rotation amount of the turbine blade wheel 17 increases, the rotation amount of the compressor impeller 19 also increases. When the rotation amount of the compressor impeller 19 increases, the pressure of the air supplied to the intake port of the engine can be sufficiently increased. As described above, the variable capacity mechanism 100 can increase the rotation amounts of the turbine blade wheel 17 and the compressor impeller 19 in a case where the flow rate of the exhaust gas is small. Hereinafter, details of the variable capacity mechanism 100 will be described.

The variable capacity mechanism 100 includes a shroud ring 101, a nozzle ring 103, a holding member 105, a drive ring 107, a transmission link 109, a link plate 111, a plurality of nozzle vanes 113, a drive mechanism 115, and an actuator 117.

The shroud ring 101 is disposed in the gap 29 on the side away from the bearing housing 3. The nozzle ring 103 is disposed in the gap 29 on the side close to the bearing housing 3. The shroud ring 101 is disposed to face the nozzle ring 103 in the axial direction. The shroud ring 101 is disposed apart from the nozzle ring 103 in the axial direction. The flow path 31 is formed between the shroud ring 101 and the nozzle ring 103.

The shroud ring 101 has an annular shape extending in the circumferential direction. The shroud ring 101 is disposed coaxially with the turbine blade wheel 17. The shroud ring 101 includes a thin ring-shaped main body 101a. The nozzle ring 103 has an annular shape extending in the circumferential direction. The nozzle ring 103 is disposed coaxially with the turbine blade wheel 17. The nozzle ring 103 includes a thin ring-shaped main body 103a.

The outer diameter of the main body 103a of the nozzle ring 103 is approximately equal to the outer diameter of the main body 101a of the shroud ring 101. However, the outer diameter of the main body 103a of the nozzle ring 103 may be larger or smaller than the outer diameter of the main body 101a of the shroud ring 101. The inner diameter of the main body 103a of the nozzle ring 103 is larger than the inner diameter of the main body 101a of the shroud ring 101. However, the inner diameter of the main body 103a of the nozzle ring 103 may coincide with the inner diameter of the main body 101a of the shroud ring 101 or may be smaller than the inner diameter of the main body 101a of the shroud ring 101.

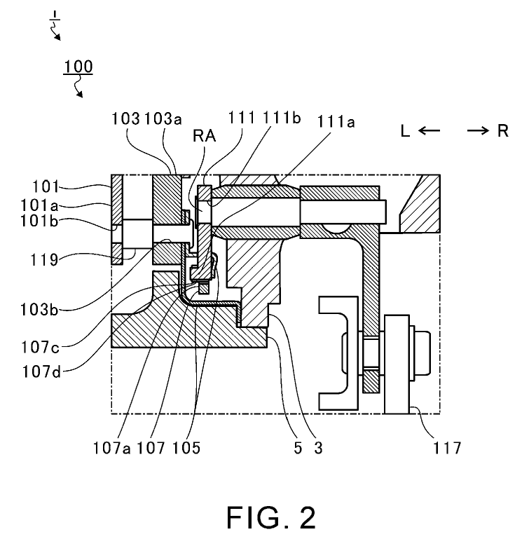

FIG. 2 is a diagram obtained by extracting a first region R1 of FIG. 1. As illustrated in FIG. 2, a plurality of pin shaft holes 101b are formed in the main body 101a of the shroud ring 101. Each of the pin shaft holes 101b penetrates the main body 101a in the axial direction. The plurality of pin shaft holes 101b are arranged apart from each other in the circumferential direction. For example, the plurality of pin shaft holes 101b are arranged at equal intervals in the circumferential direction. However, the plurality of pin shaft holes 101b may be arranged at unequal intervals in the circumferential direction.

A plurality of pin shaft holes 103b are formed in the main body 103a of the nozzle ring 103. Each of the pin shaft holes 103b penetrates the main body 103a in the axial direction. The plurality of pin shaft holes 103b are arranged apart from each other in the circumferential direction. For example, the plurality of pin shaft holes 103b are arranged at equal intervals in the circumferential direction. However, the plurality of pin shaft holes 103b may be arranged at unequal intervals in the circumferential direction.

The number of pin shaft holes 101b is equal to the number of pin shaft holes 103b. Each of the pin shaft holes 101b faces one of the pin shaft holes 103b in the axial direction. That is, each of the pin shaft holes 101b is disposed coaxially with one of the pin shaft holes 103b. A coupling pin 119 is inserted through a pin shaft hole 101b and a pin shaft hole 103b. The shroud ring 101 is coupled with the nozzle ring 103 by the coupling pins 119. The shroud ring 101 and the nozzle ring 103 are kept at a certain distance by the coupling pins 119.

The holding member 105 is disposed between the nozzle ring 103 and the bearing housing 3. The holding member 105 is coupled to the nozzle ring 103 by the coupling pins 119. In the example of FIG. 2, the holding member 105 includes two ring-shaped thin plates joined to each other. However, the holding member 105 may be constituted by one ring-shaped thin plate or may include three or more ring-shaped thin plates joined to each other.

The outer peripheral edge of the holding member 105 is clamped between the turbine housing 5 and the bearing housing 3. The holding member 105 is unrotatably held between the turbine housing 5 and the bearing housing 3. The holding member 105 holds the shroud ring 101 and the nozzle ring 103 in an unrotatable manner. The drive ring 107 is disposed between the nozzle ring 103 and the bearing housing 3. The holding member 105 holds the drive ring 107 in a relatively rotatable manner.

The drive ring 107 has an annular shape extending in the circumferential direction. The drive ring 107 is disposed coaxially with the turbine blade wheel 17. The drive ring 107 is provided on the side opposite to the plurality of nozzle vanes 113 with respect to the nozzle ring 103. As will be described later, the drive ring 107 is freely rotatably provided in conjunction with the plurality of nozzle vanes 113. The drive ring 107 corresponds to an example of an annular member freely rotatably provided in conjunction with the plurality of nozzle vanes 113.

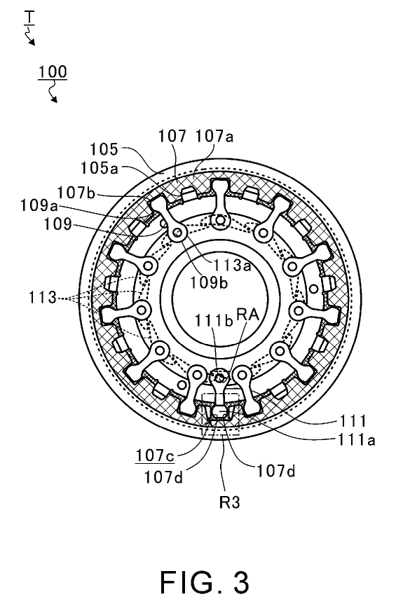

FIG. 3 is a diagram of the drive ring 107 as viewed from the bearing housing 3 side. As illustrated in FIG. 3, the drive ring 107 includes a thin ring-shaped main body 107a. The main body 107a has an annular shape extending in the circumferential direction. The main body 107a is disposed coaxially with the turbine blade wheel 17. With the inner peripheral surface of the main body 107a engaged with engaging claws 105a of the holding member 105, the main body 107a is held relatively rotatable with respect to the holding member 105. The drive ring 107 includes a plurality of transmission link engagement portions 107b and a link plate engagement portion 107c formed therein.

The transmission link engagement portion 107b is a portion of the main body 107a cut out radially outward from the inner peripheral surface of the main body 107a. The plurality of transmission link engagement portions 107b are arranged at equal intervals in the circumferential direction of the main body 107a. An engagement end 109a of a transmission link 109 is engaged with a transmission link engagement portion 107b.

The link plate engagement portion 107c is provided on the inner peripheral portion of the drive ring 107 and includes a pair of sliding surfaces 107d. The link plate engagement portion 107c is provided at one specific circumferential position in the drive ring 107. The link plate engagement portion 107c is provided between two transmission link engagement portions 107b adjacent to each other in the circumferential direction. An engagement end 111a of the link plate 111 is engaged with the pair of sliding surfaces 107d of the link plate engagement portion 107c. As described later, the link plate 111 corresponds to an example of a driving member that is rotationally driven by the actuator 117. The link plate engagement portion 107c corresponds to an example of an engagement portion with which the driving member is engaged.

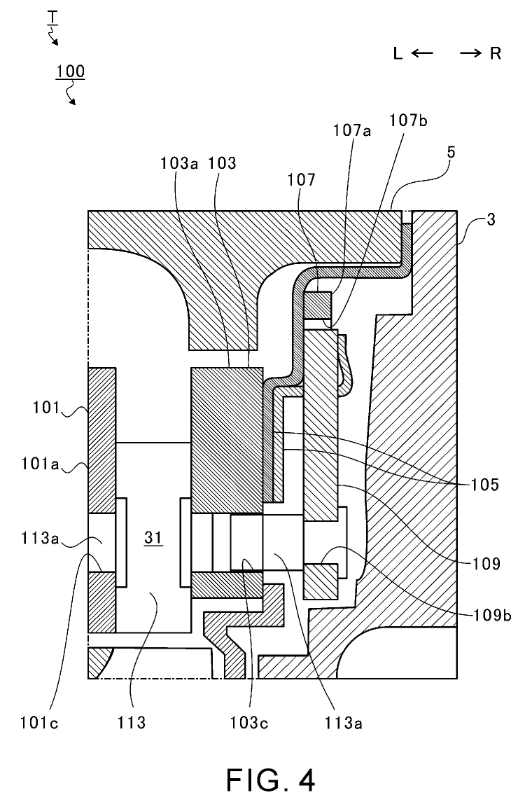

An insertion hole 109b is formed in a transmission link 109. The insertion hole 109b is formed in the transmission link 109 on the side opposite to the engagement end 109a. As illustrated in FIG. 3 and FIG. 4 described later, a bladed shaft 113a of a nozzle vane 113 is inserted into the insertion hole 109b. The transmission link 109 is caulked in a state where the bladed shaft 113a of the nozzle vane 113 is inserted into the insertion hole 109b. The transmission link 109 and the nozzle vane 113 rotate integrally with the bladed shaft 113a.

An insertion hole 111b is formed in the link plate 111. The insertion hole 111b is formed in the link plate 111 on the side opposite to the engagement end 111a. As illustrated in FIGS. 2 and 3, a rotation shaft RA of the drive mechanism 115 is inserted into the insertion hole 111b. The link plate 111 is caulked in a state where the rotation shaft RA of the drive mechanism 115 is inserted into the insertion hole 111b. The link plate 111 rotates integrally with the rotation shaft RA of the drive mechanism 115. However, the rotation shaft RA of the drive mechanism 115 may be welded to the insertion hole 111b of the link plate 111.

FIG. 4 is a diagram obtained by extracting a second region R2 of FIG. 1. As illustrated in FIG. 4, a plurality of bladed shaft holes 101c are formed in the main body 101a of the shroud ring 101. Each of the bladed shaft holes 101c is disposed radially inward with respect to the pin shaft holes 101b in the main body 101a. Each of the bladed shaft holes 101c penetrates the main body 101a in the axial direction. The plurality of bladed shaft holes 101c are arranged apart from each other in the circumferential direction. Specifically, the plurality of bladed shaft holes 101c are arranged at equal intervals in the circumferential direction.

A plurality of bladed shaft holes 103c are formed in the main body 103a of the nozzle ring 103. Each of the bladed shaft holes 103c is disposed radially inward with respect to the pin shaft holes 103b in the main body 103a. Each of the bladed shaft holes 103c penetrates the main body 103a in the axial direction. The plurality of bladed shaft holes 103c are arranged apart from each other in the circumferential direction. Specifically, the plurality of bladed shaft holes 103c are arranged at equal intervals in the circumferential direction.

The number of bladed shaft holes 103c coincides with the number of bladed shaft holes 101c. Each of the bladed shaft holes 103c faces one of the bladed shaft holes 101c in the axial direction. That is, each of the bladed shaft holes 103c is disposed coaxially with one of the bladed shaft holes 101c. A bladed shaft 113a protrudes in the axial direction from surfaces on both sides in the axial direction of each of the nozzle vanes 113. Each of the bladed shafts 113a is inserted into both a bladed shaft hole 101c and a bladed shaft hole 103c. Each of the bladed shafts 113a is freely rotatably supported by a bladed shaft hole 101c and a bladed shaft hole 103c.

The plurality of nozzle vanes 113 are arranged apart from each other in the circumferential direction in the flow path 31. That is, the plurality of nozzle vanes 113 are arranged apart from each other in the circumferential direction on the radially outer side with respect to the turbine blade wheel 17. Specifically, the plurality of nozzle vanes 113 are arranged at equal intervals in the circumferential direction. Each of the nozzle vanes 113 is provided integrally with a bladed shaft 113a in such a manner so as to be freely rotatable about the central axis of the bladed shaft 113a. That is, each of the nozzle vanes 113 is provided in such a manner so as to be freely rotatable about the rotation shaft in the axial direction of the turbine blade wheel 17.

As illustrated in FIG. 1, the actuator 117 is disposed outside the turbine housing 5, the bearing housing 3, and the compressor housing 7. The actuator 117 is, for example, a solenoid. The actuator 117 is coupled to the drive mechanism 115. The drive mechanism 115 converts the linear motion of the actuator 117 into the rotational motion of the rotation shaft RA.

When the actuator 117 is driven, the rotation shaft RA of the drive mechanism 115 rotates. When the rotation shaft RA rotates, the link plate 111 rotates integrally with the rotation shaft RA about the central axis of the rotation shaft RA. When the link plate 111 rotates, the link plate engagement portion 107c is pressed in the circumferential direction of the link plate 111, and the drive ring 107 rotates about the central axis of the drive ring 107. When the drive ring 107 rotates, the transmission link 109 is pressed in the circumferential direction by the transmission link engagement portion 107b and rotates about the central axis of the insertion hole 109b. When the transmission link 109 rotates, the bladed shaft 113a rotates integrally with the transmission link 109. When the bladed shaft 113a rotates, the nozzle vane 113 rotates integrally with the bladed shaft 113a.

When each of the nozzle vanes 113 rotates, an interval between two nozzle vanes 113 adjacent to each other in the circumferential direction changes. When the interval between the two nozzle vanes 113 adjacent to each other in the circumferential direction changes, the cross-sectional area of the flow path 31 changes. When the cross-sectional area of the flow path 31 changes, the flow velocity of exhaust gas flowing through the flow path 31 changes.

The variable capacity mechanism 100 changes the interval between two nozzle vanes 113 adjacent to each other in the circumferential direction by rotating the plurality of nozzle vanes 113 depending on the flow rate of exhaust gas. This makes the opening degree of the nozzle vanes 113 change. As the extending direction of the nozzle vanes 113 is closer to the circumferential direction of the turbine blade wheel 17, the interval between two nozzle vanes 113 adjacent to each other in the circumferential direction becomes narrower, and the opening degree of the nozzle vanes 113 becomes smaller. On the other hand, as the angle formed by the extending direction of the nozzle vanes 113 and the circumferential direction of the turbine blade wheel 17 increases, the interval between two nozzle vanes 113 adjacent to each other in the circumferential direction increases, and the opening degree of the nozzle vanes 113 increases.

The opening degree of the nozzle vanes 113 can be adjusted within a range having an upper limit and a lower limit. When the nozzle vanes 113 are fully closed, the extending direction of the nozzle vanes 113 is the closest to the circumferential direction of the turbine blade wheel 17, and the opening degree of the nozzle vanes 113 is the smallest. On the other hand, when the nozzle vanes 113 are fully open, the angle formed by the extending direction of the nozzle vanes 113 and the circumferential direction of the turbine blade wheel 17 is the largest, and the opening degree of the nozzle vanes 113 is the largest. The smaller the opening degree of the nozzle vane 113 is, the smaller the flow path cross-sectional area of the flow path 31 is.

For example, when the flow rate of the exhaust gas is small, the variable capacity mechanism 100 decreases the opening degree of the nozzle vanes 113 and increases the flow velocity of the exhaust gas. As a result, the variable capacity mechanism 100 can increase the rotation amount of the turbine blade wheel 17 even when the flow rate of the exhaust gas is small. As a result, the variable capacity mechanism 100 can increase the rotation amount of the compressor impeller 19 even when the flow rate of the exhaust gas is small.

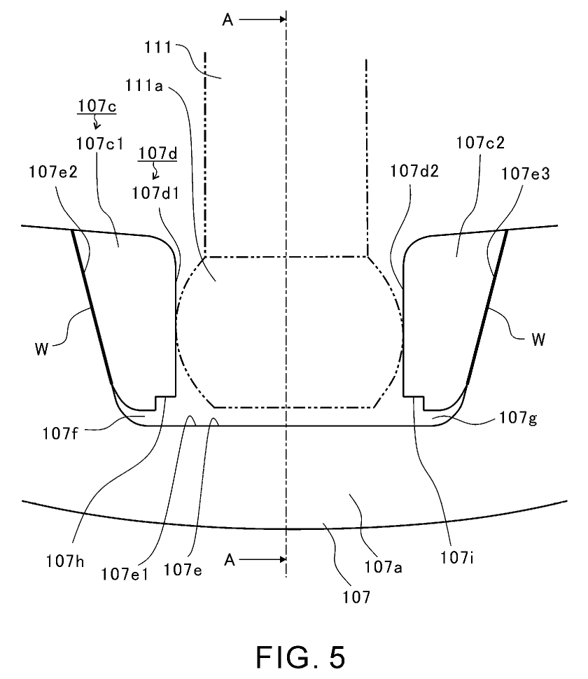

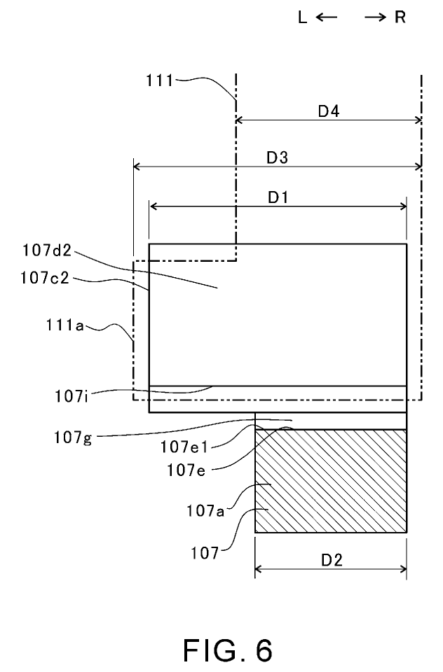

As described above, each nozzle vane 113 rotates in conjunction with the drive ring 107 which is an annular member rotated by the actuator 117. The drive ring 107 is provided with the link plate engagement portion 107c including the pair of sliding surfaces 107d. The link plate 111 which is the driving member rotationally driven by the actuator 117 is slidably engaged with the pair of sliding surfaces 107d of the link plate engagement portion 107c. As the link plate 111 slides, the link plate engagement portion 107c or the link plate 111 wears. In the present embodiment, the drive ring 107 is devised to suppress such wear. Hereinafter, details of the drive ring 107 will be described with reference to FIGS. 5 and 6.

FIG. 5 is a diagram obtained by extracting a third region R3 of FIG. 3. As illustrated in FIG. 5, the link plate engagement portion 107c of the drive ring 107 includes a first engagement portion 107c1 and a second engagement portion 107c2. The first engagement portion 107c1 and the second engagement portion 107c2 are separated from each other in the circumferential direction. The pair of sliding surfaces 107d includes a first facing surface 107d1 facing the second engagement portion 107c2 in the first engagement portion 107c1 and a second facing surface 107d2 facing the first engagement portion 107c1 in the second engagement portion 107c2. The engagement end 111a of the link plate 111 is slidably engaged with the first facing surface 107d1 and the second facing surface 107d2.

A recessed portion 107e is provided in the main body 107a of the drive ring 107. The main body 107a corresponds to a portion of the drive ring 107 excluding the link plate engagement portion 107c and is a separate body from the link plate engagement portion 107c. The recessed portion 107e is formed to be recessed in the radial direction from the inner peripheral surface of the main body 107a. The width of the recessed portion 107e in the circumferential direction is shorter as it is closer to a bottom 107e1. In the example of FIG. 5, the recessed portion 107e has a trapezoidal shape when viewed in the axial direction. The bottom 107e1 corresponds to the upper base of the trapezoidal shape. Side surfaces 107e2 and 107e3 of the recessed portion 107e in the circumferential direction correspond to oblique sides of the trapezoidal shape. In the recessed portion 107e, the circumferential distance between the side surface 107e2 and the side surface 107e3 decreases as it is closer to the bottom 107e1.

The first engagement portion 107c1 is joined to the side surface 107e2 of the recessed portion 107e by welding. Therefore, the first engagement portion 107c1 is joined to the side surface 107e2 of the recessed portion 107e via a welding portion W. The second engagement portion 107c2 is joined to the side surface 107e3 of the recessed portion 107e by welding. Therefore, the second engagement portion 107c2 is joined to the side surface 107e3 of the recessed portion 107e via a welding portion W.

The first facing surface 107d1 of the first engagement portion 107c1 and the second facing surface 107d2 of the second engagement portion 107c2 face each other in the circumferential direction. The first facing surface 107d1 and the second facing surface 107d2 each extend on a plane intersecting the circumferential direction. The first facing surface 107d1 and the second facing surface 107d2 are, for example, parallel to each other.

The first engagement portion 107c1 is joined to the side surface 107e2 of the recessed portion 107e, but is not joined to the bottom 107e1, and is separated from the bottom 107e1 in the radial direction. Therefore, a first gap 107f is formed between the bottom 107e1 and the first engagement portion 107c1. A radially outer portion of the first engagement portion 107c1 faces the bottom 107e1. That is, the first gap 107f is a gap between the radially outer portion of the first engagement portion 107c1 and the bottom 107e1. The first gap 107f is formed due to a manufacturing process of the drive ring 107 described later.

The second engagement portion 107c2 is joined to the side surface 107e3 of the recessed portion 107e, but is not joined to the bottom 107e1, and is separated from the bottom 107e1 in the radial direction. Therefore, a second gap 107g is formed between the bottom 107e1 and the second engagement portion 107c2. A radially outer portion of the second engagement portion 107c2 faces the bottom 107e1. That is, the second gap 107g is a gap between the radially outer portion of the second engagement portion 107c2 and the bottom 107e1. The second gap 107g is formed due to the manufacturing process of the drive ring 107 described later.

A first groove 107h recessed in a direction away from the bottom 107e1 is provided on the second engagement portion 107c2 side in the portion of the first engagement portion 107c1 facing the bottom 107e1. In other words, the first groove 107h is provided on the side opposite to the side surface 107e2 in the radially outer portion of the first engagement portion 107c1, and is recessed radially inward. The first groove 107h is formed due to the manufacturing process of the drive ring 107 described later.

A second groove 107i recessed in a direction away from the bottom 107e1 is provided on the first engagement portion 107c1 side in the portion of the second engagement portion 107c2 facing the bottom 107e1. In other words, the second groove 107i is provided on the side opposite to the side surface 107e3 in the radially outer portion of the second engagement portion 107c2, and is recessed radially inward. The second groove 107i is formed due to the manufacturing process of the drive ring 107 described later.

FIG. 6 is a cross-sectional view taken along line A-A in FIG. 5. The A-A cross section is a cross section that passes through the engagement end 111a of the link plate 111 and is orthogonal to the circumferential direction. In FIG. 6, only the second engagement portion 107c2 out of the first engagement portion 107c1 and the second engagement portion 107c2 is illustrated. However, the shape of the first engagement portion 107c1 and the shape of the second engagement portion 107c2 are symmetrical about the A-A cross section. Hereinafter, the thickness of a member refers to the length in the axial direction.

As illustrated in FIG. 6, a thickness D1 of the second engagement portion 107c2 is larger than a thickness D2 of the main body 107a. In the example of FIG. 6, the axial position of the right end of the second engagement portion 107c2 coincides with the axial position of the right end of the main body 107a. Meanwhile, the left end of the second engagement portion 107c2 is located on the left side of the left end of the main body 107a. The thickness of the first engagement portion 107c1 coincides with the thickness D1 of the second engagement portion 107c2. Therefore, the thickness D1 of the link plate engagement portion 107c is thicker than the thickness D2 of the peripheral portion of the drive ring 107.

A thickness D3 of the engagement end 111a of the link plate 111 is thicker than a thickness D4 of a portion of the link plate 111 excluding the engagement end 111a. In the example of FIG. 6, the axial position of the right end of the engagement end 111a coincides with the axial position of the right end of the portion of the link plate 111 excluding the engagement end 111a. Meanwhile, the left end of the engagement end 111a is located on the left side of the left end of the portion of the link plate 111 excluding the engagement end 111a.

The thickness D4 of the portion of the link plate 111 excluding the engagement end 111a is larger than the thickness D2 of the main body 107a. In the example of FIG. 6, the right end of the portion of the link plate 111 excluding the engagement end 111a is located on the right side of the right end of the main body 107a. The left end of the portion of the link plate 111 excluding the engagement end 111a is positioned on the left side of the left end of the main body 107a.

The thickness D3 of the engagement end 111a is larger than the thickness D1 of the link plate engagement portion 107c. In the example of FIG. 6, the right end of the engagement end 111a is located on the right side of the right end of the second engagement portion 107c2. The left end of the engagement end 111a is located on the left side of the left end of the second engagement portion 107c2.

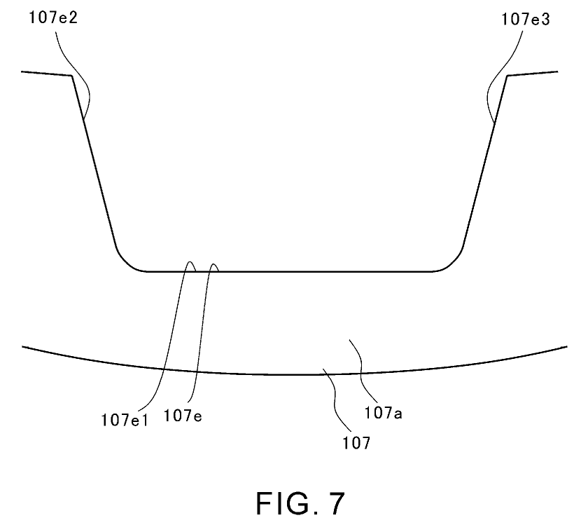

Hereinafter, the manufacturing process of the drive ring 107 according to the present embodiment will be described with reference to FIGS. 7 to 9.

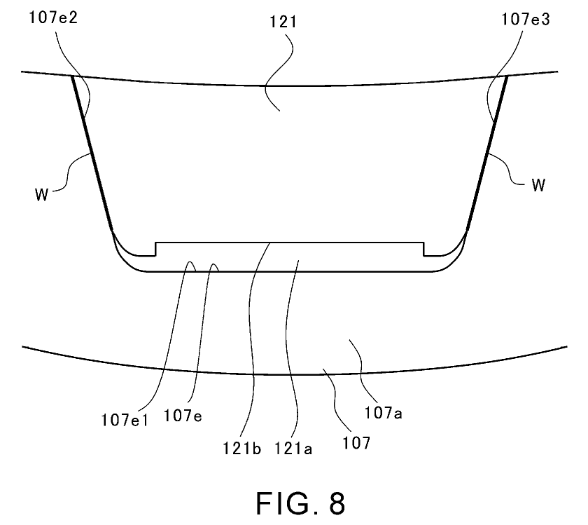

In the manufacturing process of the drive ring 107, a first step of preparing the main body 107a, a second step of joining a thick member (see a thick member 121 in FIG. 8 described later) to the recessed portion 107e of the main body 107a by welding, and a third step of forming the first engagement portion 107c1 and the second engagement portion 107c2 by cutting the thick member are performed in this order.

FIG. 7 is a diagram for explaining a first step in the manufacturing process of the drive ring 107 according to the present embodiment. In the first step, the main body 107a is prepared which corresponds to the portion of the drive ring 107 excluding the link plate engagement portion 107c, is separate from the link plate engagement portion 107c, and extends in the circumferential direction. In particular, as illustrated in FIG. 7, in the first step, the recessed portion 107e, in which the width in the circumferential direction decreases as it is closer to the bottom 107e1, is formed to be recessed from the inner peripheral surface of the main body 107a. For example, the main body 107a is formed by subjecting a thin plate as a material to punching. In this case, the recessed portion 107e is formed by, for example, the punching.

FIG. 8 is a diagram for explaining a second step in the manufacturing process of the drive ring 107 according to the present embodiment. The second step is performed subsequent to the first step. In the second step, the thick member 121 having the thickness D1 thicker than the thickness D2 of the main body 107a is joined to the recessed portion 107e by welding. The thick member 121 corresponds to the material of the first engagement portion 107c1 and the second engagement portion 107c2. The thick member 121 has the same thickness D1 as the thickness D1 of the first engagement portion 107c1 and the second engagement portion 107c2.

As illustrated in FIG. 8, in the second step, the thick member 121 is joined to the side surfaces 107e2 and 107e3 on both sides in the circumferential direction of the recessed portion 107e by welding. Therefore, the thick member 121 is joined to the side surface 107e2 of the recessed portion 107e via the welding portion W and is also joined to the side surface 107e3 of the recessed portion 107e via the welding portion W.

The thick member 121 is joined to the side surfaces 107e2 and 107e3 of the recessed portion 107e, but is not joined to the bottom 107e1, and is separated from the bottom 107e1 in the radial direction. Therefore, a gap 121a is formed between the bottom 107e1 and the thick member 121. By forming the gap 121a in the second step, as will be described later, in the third step, the first gap 107f between the bottom 107e1 and the first engagement portion 107c1 and the second gap 107g between the bottom 107e1 and the second engagement portion 107c2 are formed.

A groove 121b recessed in a direction away from the bottom 107e1 is formed at a circumferential central portion of a portion of the thick member 121 facing the bottom 107e1. Since the groove 121b is formed in the thick member 121, the first groove 107h of the first engagement portion 107c1 and the second groove 107i of the second engagement portion 107c2 are formed in the third step as described later.

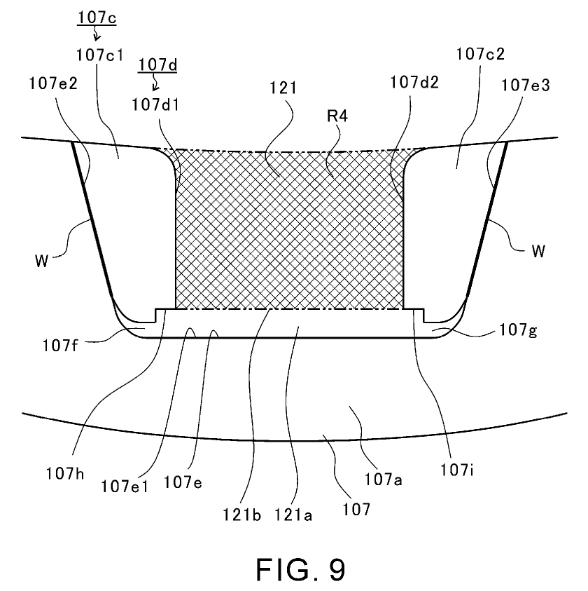

FIG. 9 is a diagram for explaining a third step in the manufacturing process of the drive ring 107 according to the present embodiment. The third step is performed subsequently to the second step. In the third step, the first engagement portion 107c1 and the second engagement portion 107c2 are formed by cutting the thick member 121.

A region R4 of the thick member 121 illustrated in FIG. 9 is cut and removed. As illustrated in FIG. 9, the region R4 is a region of the thick member 121 excluding both sides in the circumferential direction. For example, the thick member 121 is cut by a blade such as an end mill. As a result, the first engagement portion 107c1 and the second engagement portion 107c2 are formed as the link plate engagement portion 107c. The first engagement portion 107c1 is a portion joined to the side surface 107e2 in a portion remaining after the region R4 is removed from the thick member 121. The second engagement portion 107c2 is a portion joined to the side surface 107e3 in the portion remaining after the region R4 is removed from the thick member 121.

By cutting the thick member 121 as described above, the first facing surface 107d1 of the first engagement portion 107c1 and the second facing surface 107d2 of the second engagement portion 107c2 are formed as the pair of sliding surfaces 107d.

By forming the gap 121a in the second step, the first gap 107f between the bottom 107e1 and the first engagement portion 107c1 and the second gap 107g between the bottom 107e1 and the second engagement portion 107c2 are formed after cutting the thick member 121 in the third step. That is, in the manufacturing process of the drive ring 107, the thick member 121 is welded to the recessed portion 107e such that the first gap 107f is formed between the bottom 107e1 and the first engagement portion 107c1 and that the second gap 107g is formed between the bottom 107e1 and the second engagement portion 107c2.

Since the groove 121b is formed in the thick member 121 as described above, the first groove 107h of the first engagement portion 107c1 and the second groove 107i of the second engagement portion 107c2 are formed after the thick member 121 is cut in the third step. That is, in the manufacturing process of the drive ring 107, the thick member 121 is cut such that the first groove 107h of the first engagement portion 107c1 and the second groove 107i of the second engagement portion 107c2 are formed.

As described above, in the turbine T according to the present embodiment, the link plate engagement portion 107c, which is an engagement portion including the pair of sliding surfaces 107d facing each other in the circumferential direction, is provided on the drive ring 107, which is an annular member rotatably provided in conjunction with the plurality of nozzle vanes 113. The link plate 111 which is the driving member rotationally driven by the actuator 117 is slidably engaged with the pair of sliding surfaces 107d. The link plate engagement portion 107c has the thickness D1 thicker than the thickness D2 of the peripheral portion of the drive ring 107.

In addition, the manufacturing method of the turbine T according to the present embodiment includes the steps of: preparing the turbine blade wheel 17; arranging the plurality of nozzle vanes 113 apart from each other in a circumferential direction of the turbine blade wheel 17 on a radially outer side of the turbine blade wheel 17 and providing the plurality of nozzle vanes 113 in a freely rotatable manner about a rotation shaft in the axial direction of the turbine blade wheel 17; providing the drive ring 107, which is an annular member extending in the circumferential direction, in a freely rotatable manner in conjunction with the plurality of nozzle vanes 113; and providing the link plate engagement portion 107c to the drive ring 107, the link plate engagement portion 107c including the pair of sliding surfaces 107d facing each other in the circumferential direction, the link plate 111, which is a driving member rotatably driven by the actuator 117, slidably engaged with the pair of sliding surfaces 107d, the link plate engagement portion 107c being an engagement portion having the thickness D1 thicker than the thickness D2 of a peripheral portion of the drive ring 107.

According to the turbine T and the manufacturing method of the turbine T, the contact area between the link plate engagement portion 107c and the engagement end 111a of the link plate 111 can be increased. Therefore, the surface pressure generated between the link plate engagement portion 107c and the engagement end 111a of the link plate 111 can be reduced. Therefore, wear of the link plate engagement portion 107c or the link plate 111 due to sliding of the link plate 111 can be suppressed.

An example of the thicknesses of the drive ring 107 and the link plate 111 has been described above with reference to FIG. 6. However, the thicknesses of the drive ring 107 and the link plate 111 are not limited to the above example. For example, the thickness D2 of the main body 107a of the drive ring 107 may be constant or may vary depending on the position. For example, the thickness D4 of the portion of the link plate 111 excluding the engagement end 111a may coincide with the thickness D3 of the engagement end 111a of the link plate 111, or may be thicker than the thickness D3.

In particular, in the manufacturing method of the turbine T according to the present embodiment, providing the link plate engagement portion 107c in the drive ring 107 includes preparing the main body 107a, which corresponds to the portion of the drive ring 107 excluding the link plate engagement portion 107c, is a separate body from the link plate engagement portion 107c, and extends in the circumferential direction, and joining the link plate engagement portion 107c to the main body 107a by welding. Thus, in the turbine T according to the present embodiment, the drive ring 107 includes the main body 107a corresponds to the portion of the drive ring 107 excluding the link plate engagement portion 107c, is separate from the link plate engagement portion 107c, and extends in the circumferential direction, and the link plate engagement portion 107c is joined to the main body 107a via at least one welding portion W.

According to the turbine T and the manufacturing method of the turbine T, the processing cost can be reduced as compared with the case where the link plate engagement portion 107c and the main body 107a are integrally formed by shaving or the like. In addition, unlike the case where the link plate engagement portion 107c is press-fitted into the main body 107a, it is possible to suppress generation of stress due to press-fitting and to suppress cracking or the like of the members. However, the link plate engagement portion 107c and the main body 107a may be integrally formed by shaving or the like. The link plate engagement portion 107c may be press-fitted into the main body 107a.

In particular, in the manufacturing method of the turbine T according to the present embodiment, preparing the main body 107a includes forming the recessed portion 107e in which the width in the circumferential direction decreases as it is closer to the bottom 107e1 by being recessed from the peripheral surface of the main body 107a, and joining the link plate engagement portion 107c to the main body 107a includes joining the link plate engagement portion 107c to each of the side surfaces 107e2 and 107e3 on both sides in the circumferential direction of the recessed portion 107e by welding. Accordingly, in the turbine T according to the present embodiment, the main body 107a includes the recessed portion 107e which is formed to be recessed from the peripheral surface of the main body 107a and whose width in the circumferential direction decreases as it is closer to the bottom 107e1, and the link plate engagement portion 107c is joined to each of the side surfaces 107e2 and 107e3 on both sides in the circumferential direction of the recessed portion 107e via the welding portion W.

According to the turbine T and the manufacturing method of the turbine T, since the width in the circumferential direction of the recessed portion 107e decreases as it is closer to the bottom 107e1, the link plate engagement portion 107c is appropriately welded to each of the side surfaces 107e2 and 107e3 of the recessed portion 107e. Therefore, the link plate engagement portion 107c can be appropriately positioned after being joined to the main body 107a by welding instead of press-fitting. However, the shape and the position of the recessed portion 107e are not limited to the above example. For example, the width in the circumferential direction of the recessed portion 107e may be constant regardless of the radial position. For example, the recessed portion 107e may be recessed from the outer peripheral surface of the main body 107a.

In particular, in the manufacturing method of the turbine T according to the present embodiment, joining the link plate engagement portion 107c to the main body 107a includes: joining the thick member 121 having the thickness D1 thicker than the thickness D2 of the main body 107a to the side surfaces 107e2 and 107e3 on both sides in the circumferential direction of the recessed portion 107e by welding; and forming, as the link plate engagement portion 107c, by cutting the thick member 121, the first engagement portion 107c1 joined to a first side surface 107e2 of the recessed portion 107e in the circumferential direction by welding and the second engagement portion 107c2 joined to a second side surface 107e3 of the recessed portion 107e in the circumferential direction by welding and separated from the first engagement portion 107c1 in the circumferential direction, and forming, as the pair of sliding surfaces 107d, the first facing surface 107d1 of the first engagement portion 107c1 facing the second engagement portion 107c2 and the second facing surface 107d2 of the second engagement portion 107c2 facing the first engagement portion 107c1. As a result, in the turbine T according to the present embodiment, the link plate engagement portion 107c includes the first engagement portion 107c1 joined to the first side surface 107e2 in the circumferential direction of the recessed portion 107e via the welding portion W and the second engagement portion 107c2 joined to the second side surface 107e3 in the circumferential direction of the recessed portion 107e via the welding portion W and separated from the first engagement portion 107c1 in the

circumferential direction, and the pair of sliding surfaces 107d includes the first facing surface 107d1 facing the second engagement portion 107c2 in the first engagement portion 107c1 and the second facing surface 107d2 facing the first engagement portion 107c1 in the second engagement portion 107c2.

According to the turbine T and the manufacturing method of the turbine T, the first engagement portion 107c1 and the second engagement portion 107c2 can be formed and the first facing surface 107d1 and the second facing surface 107d2 can be formed by a simple step of welding the thick member 121 to the recessed portion 107e and cutting the thick member 121. However, the link plate engagement portion 107c may be an integrally formed member instead of a plurality of members separated from each other. For example, unlike the example of FIG. 9, the region R4 of the thick member 121 to be cut may not reach the groove 121b, and the first engagement portion 107c1 and the second engagement portion 107c2 may be connected without being divided.

In particular, in the manufacturing method of the turbine T according to the present embodiment, joining the link plate engagement portion 107c to the main body 107a includes joining the thick member 121 to the side surfaces 107e2 and 107e3 on both sides in the circumferential direction of the recessed portion 107e by welding such that the first gap 107f is formed between the bottom 107e1 and the first engagement portion 107c1 and that the second gap 107g is formed between the bottom 107e1 and the second engagement portion 107c2. Accordingly, in the turbine T according to the present embodiment, the first gap 107f is formed between the bottom 107e1 and the first engagement portion 107c1, and the second gap 107g is formed between the bottom 107e1 and the second engagement portion 107c2.

According to the turbine T and the manufacturing method of the turbine T, the bottom 107e1 and the first engagement portion 107c1 are not welded, and the bottom 107e1 and the second engagement portion 107c2 are not welded. This makes it possible to suppress an increase in thermal stress accompanying an increase in the welding area. Therefore, cracking or the like of the members due to thermal stress can be suppressed. However, the bottom 107e1 and the first engagement portion 107c1 may be welded, and the bottom 107e1 and the second engagement portion 107c2 may be welded. For example, the thick member 121 may be welded to the bottom 107e1 once the thick member 121 is welded to the recessed portion 107e.

In particular, in the manufacturing method of the turbine T according to the present embodiment, joining the link plate engagement portion 107c to the main body 107a includes cutting the thick member 121 such that the first groove 107h recessed in the direction away from the bottom 107e1 is formed on the second engagement portion 107c2 side in the portion of the first engagement portion 107c1 facing the bottom 107e1 and that the second groove 107i recessed in the direction away from the bottom 107e1 is formed on the first engagement portion 107c1 side in the portion of the second engagement portion 107c2 facing the bottom 107e1. Therefore, in the turbine T according to the present embodiment, the first groove 107h recessed in the direction away from the bottom 107e1 is provided on the second engagement portion 107c2 side in the portion of the first engagement portion 107c1 facing the bottom 107e1, and the second groove 107i recessed in the direction away from the bottom 107e1 is provided on the first engagement portion 107c1 side in the portion of the second engagement portion 107c2 facing the bottom 107e1.

According to the turbine T and the manufacturing method of the turbine T, it is possible to suppress burrs or cutting chips generated at the time of cutting the thick member 121 from remaining between the bottom 107e1 and the first engagement portion 107c1 or between the bottom 107e1 and the second engagement portion 107c2. For example, burrs or cutting chips generated in the vicinity of the first engagement portion 107c1 at the time of cutting of the thick member 121 are guided to the first groove 107h, whereby the burrs or cutting chips are less likely to enter the side surface 107e2 side than the first groove 107h in the first gap 107f. For example, burrs or cutting chips generated in the vicinity of the second engagement portion 107c2 during cutting of the thick member 121 are guided to the second groove 107i, whereby the burrs or cutting chips are less likely to enter the side surface 107e3 side than the second groove 107i in the second gap 107g. However, the first groove 107h may not be formed in the first engagement portion 107c1, and the second groove 107i may not be formed in the second engagement portion 107c2.

Although the embodiments of the present disclosure have been described with reference to the accompanying drawings, it is naturally understood that the present disclosure is not limited to the above embodiments. It is clear that those skilled in the art can conceive various modifications or variations within the scope described in the claims, and it is understood that they are naturally also within the technical scope of the present disclosure.

The example in which the turbine T is mounted on the turbocharger TC has been described above. However, the device on which the turbine T is mounted may be a device other than the turbocharger TC.

1. A turbine comprising:
a turbine blade wheel;
a plurality of nozzle vanes arranged apart from each other in a circumferential direction of the turbine blade wheel on a radially outer side of the turbine blade wheel, the plurality of nozzle vanes provided in a freely rotatable manner about a rotation shaft in an axial direction of the turbine blade wheel;
an annular member extending in the circumferential direction and freely rotatably provided in conjunction with the plurality of nozzle vanes; and
an engagement portion including a pair of sliding surfaces provided on the annular member and facing each other in the circumferential direction, a driving member rotatably driven by an actuator being slidably engaged with the pair of sliding surfaces, the engagement portion having a thickness thicker than a thickness of a peripheral portion of the annular member.

2. The turbine according to claim 1, wherein
the annular member includes a main body corresponds to a portion of the annular member excluding the engagement portion, is separate from the engagement portion, and extends in the circumferential direction, and
the engagement portion is joined to the main body via at least one welding portion.

3. The turbine according to claim 2, wherein
the main body includes a recessed portion recessed from a peripheral surface of the main body, a width in the circumferential direction of the recessed portion decreasing as the recessed portion is closer to a bottom, and
the engagement portion is joined to side surfaces of the recessed portion on both sides in the circumferential direction via the welding portion.

4. The turbine according to claim 3, wherein
the engagement portion includes a first engagement portion joined to a first side surface of the recessed portion in the circumferential direction via the welding portion and a second engagement portion joined to a second side surface of the recessed portion in the circumferential direction via the welding portion, the second engagement portion separated from the first engagement portion in the circumferential direction, and
the pair of sliding surfaces includes a first facing surface of the first engagement portion, the first facing surface facing the second engagement portion and a second facing surface of the second engagement portion, the second facing surface facing the first engagement portion.

5. The turbine according to claim 4, wherein
a first gap is formed between the bottom and the first engagement portion, and
a second gap is formed between the bottom and the second engagement portion.

6. The turbine according to claim 5, wherein
a first groove recessed in a direction away from the bottom is formed on a side of the second engagement portion in a portion of the first engagement portion facing the bottom, and
a second groove recessed in a direction away from the bottom is provided on a side of the first engagement portion in a portion of the second engagement portion facing the bottom.

7. A manufacturing method of a turbine, the method comprising the steps of:
preparing a turbine blade wheel;
arranging a plurality of nozzle vanes apart from each other in a circumferential direction of the turbine blade wheel on a radially outer side of the turbine blade wheel and providing the plurality of nozzle vanes in a freely rotatable manner about a rotation shaft in an axial direction of the turbine blade wheel;
providing an annular member extending in the circumferential direction in a freely rotatable manner in conjunction with the plurality of nozzle vanes; and
providing an engagement portion to the annular member, the engagement portion including a pair of sliding surfaces facing each other in the circumferential direction, a driving member rotatably driven by an actuator being slidably engaged with the pair of sliding surfaces, the engagement portion having a thickness thicker than a thickness of a peripheral portion of the annular member.

8. The manufacturing method of a turbine according to claim 7, wherein
the step of providing the engagement portion to the annular member includes the steps of:
preparing a main body corresponding to a portion of the annular member excluding the engagement portion, the main body being a separate body from the engagement portion and extending in the circumferential direction; and
joining the engagement portion to the main body by welding.

9. The manufacturing method of a turbine according to claim 8, wherein
the step of preparing the main body includes the step of forming a recessed portion in such a manner as to be recessed from a peripheral surface of the main body, the recessed portion in which a width in the circumferential direction decreases as the recessed portion is closer to a bottom, and
the step of joining the engagement portion to the main body includes the step of joining the engagement portion to side surfaces of the recessed portion on both sides in the circumferential direction by welding.

10. The manufacturing method of a turbine according to claim 9, wherein
the step of joining the engagement portion to the main body includes the steps of:
joining a thick member having a thickness thicker than a thickness of the main body to side surfaces of the recessed portion on both sides in the circumferential direction by welding; and
forming, as the engagement portion, by cutting the thick member, a first engagement portion joined to a first side surface of the recessed portion in the circumferential direction by welding and a second engagement portion joined to a second side surface of the recessed portion in the circumferential direction by welding and separated from the first engagement portion in the circumferential direction, and forming, as the pair of sliding surfaces, a first facing surface of the first engagement portion facing the second engagement portion and a second facing surface of the second engagement portion facing the first engagement portion.

11. The manufacturing method of a turbine according to claim 10, wherein
the step of joining the engagement portion to the main body includes the step of:
joining the thick member to each of the side surfaces of the recessed portion on both sides in the circumferential direction by welding such that a first gap is formed between the bottom and the first engagement portion and a second gap is formed between the bottom and the second engagement portion.

12. The manufacturing method of a turbine according to claim 11, wherein
the step of joining the engagement portion to the main body includes the step of:
cutting the thick member such that a first groove recessed in a direction away from the bottom is formed on a side of the second engagement portion in a portion of the first engagement portion facing the bottom and that a second groove recessed in a direction away from the bottom is provided on a side of the first engagement portion in a portion of the second engagement portion facing the bottom.
